(19) United States
(12) Patent Application Publication
(10) Pub. No.: US 2008/0100719 A1
(43) Pub. Date: May 1, 2008

(54) Electronic device

(75) Inventor: Wei-Pin Huang, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/657,103

(22) Filed: Jan. 24, 2007

(30) Foreign Application Priority Data
Nov. 1, 2006 (TW) 095140489

(51) Int. Cl. H04N 5/232

(52) U.S. Cl. 348/211.99

(57) ABSTRACT

An electronic device includes a host, a microphone module, a first camera module, a second camera module, a driving module and a control module. The microphone module is connected to the host. The first camera module and the second camera module are respectively disposed at two opposite sides of the host. The driving module disposed in the host drives the first camera module or the second camera module to turn. The control module disposed in the host is connected to the microphone module, the first camera module, the second camera module and the driving m

### BACKGROUND OF THE INVENTION

1. Field of Invention

The invention relates to an electronic device and in particular, to an electronic device capable of facilitating a video conference.

2. Related Art

Currently, with the continuously advanced network technology, communication through networks becomes more and more common. In addition, with the increase in network bandwidth and the development of voice and image compression technology, users may communicate with each other without being restricted by the space and distance.

Generally speaking, a video conference system includes a computer device, a microphone device and a network camera. When the users want to have a video conference, the computer device is first connected to another remote computer device through a network. Then, the network camera photographs an image of the user and the microphone device receives the user's voice. Next, the computer device can transmit the image and the voice to the remote computer device through the network. Consequently, the remote user can receive images and voice through the display and the speaker of the remote computer device.

Both the user and the remote user need to have a computer device, a microphone device, a speaker device, a display device and a network camera in order to perform the video conference. In other words, the number of devices in the conventional video conference system is quite a few, and also the connection between the devices is complicated. Therefore, preparing the video conference could be time-consuming and inconvenient.

In addition, the telecommunication technology has been developed and evolved to the third generation (3G) systems: therefore, the 3G portable electronic device (e.g. the mobile phone or personal digital assistant (PDA)) has a high network transmission rate and the advantage of a voice/image acquiring function. If the portable electronic device itself can possess the function of the video conference, the equipments used in traditional video conference can be mostly neglect so that the conferences can be indeed held with greater convenience and portability.

Thus, it is an important objective of the invention to provide an electronic device for a video conference.

### SUMMARY OF THE INVENTION

In view of the foregoing, the invention is to provide an electronic device, which may be used in a video conference.

To achieve the above, the invention discloses an electronic device, which includes a host, a microphone module a first camera module, a second camera module, a driving module and a control module. The microphone module is connected to the host. The first camera module and the second camera module are respectively disposed on two opposite sides of the host. The driving module disposed in the host drives the first camera module or the second camera module to turn. The control module disposed in the host is connected to the microphone module, the first camera module, the second camera module and the driving module.

As mentioned above, the electronic device of the invention having the microphone module, the first camera module and the second camera module can directly communicate with the remote electronic device to perform voice and image transmission. Compared with the prior art, the invention can indeed eliminate the trouble of preparing too many devices to construct the conventional video conference system and also shorten the time of connecting the devices together so that the video conference can be performed conveniently. In addition, the microphone module can receive the voice coming from any direction and the control module can judge to adjust the first camera module or to enable the second camera module to photograph the image according to the voice source, and adjust the position and the focal length of each camera module. Consequently, the electronic device of the invention not only has the advantage of receiving voice but also can photograph images quickly, automatically and precisely. In addition, the electronic device of the invention may further include the remote control module, which may have a voice receiving unit for receiving the voice such that the voice-receiving range of the electronic device may be increased. In addition, the user may also manually control the position or the focal length of the first camera module or the second camera module through the remote control module thus making the image photographed by each camera module more precise and clear so as to facilitate the video conference.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing an electronic device according to a preferred embodiment of the invention, wherein a microphone module is oriented in a functioning position;

FIG. 2A is a schematic illustration showing the electronic device according to the preferred embodiment of the invention, wherein a first camera module is disposed within a first photographing range;

FIG. 2B is a schematic illustration showing the electronic device according to the preferred embodiment of the invention wherein a second camera module is disposed within a second photographing range;

FIG. 3 is a schematic illustration showing the electronic device according to the preferred embodiment of the invention, wherein the microphone module is oriented in a retracted position; and

FIG. 4 is a schematic illustration showing a remote control module of the electronic device according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

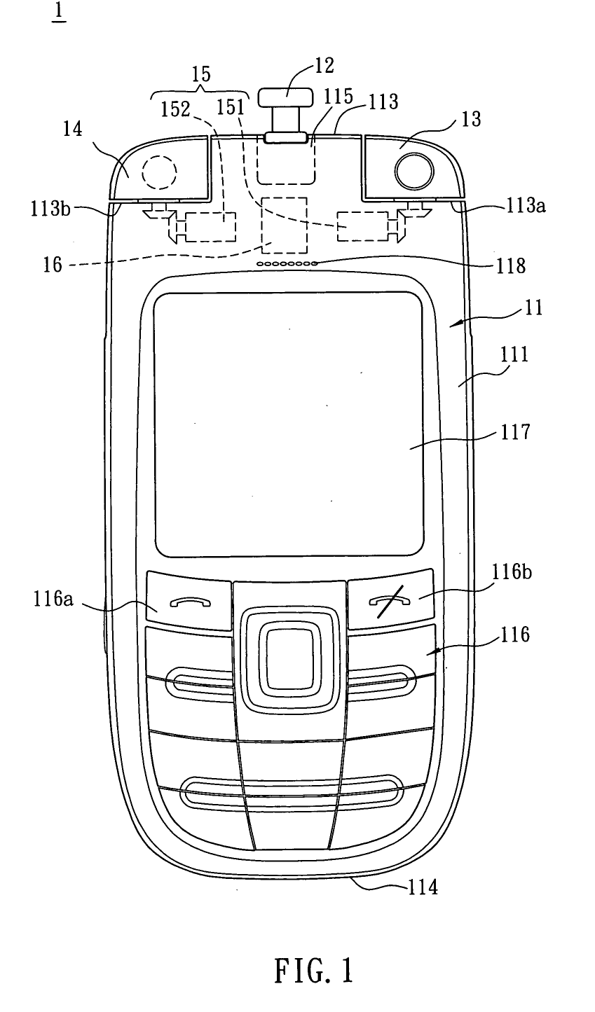

FIG. 1 shows an electronic device 1 according to a preferred embodiment of the invention. In this embodiment, the electronic device 1 is a mobile phone. Of course, the electronic device 1 may also be any other portable electronic device, such as a personal digital assistant (PDA). Referring to FIG. 1, the electronic device 1 includes a host 11, a microphone module 12, a first camera module 13 a second camera module 14, a driving module 15 and a control module 16.

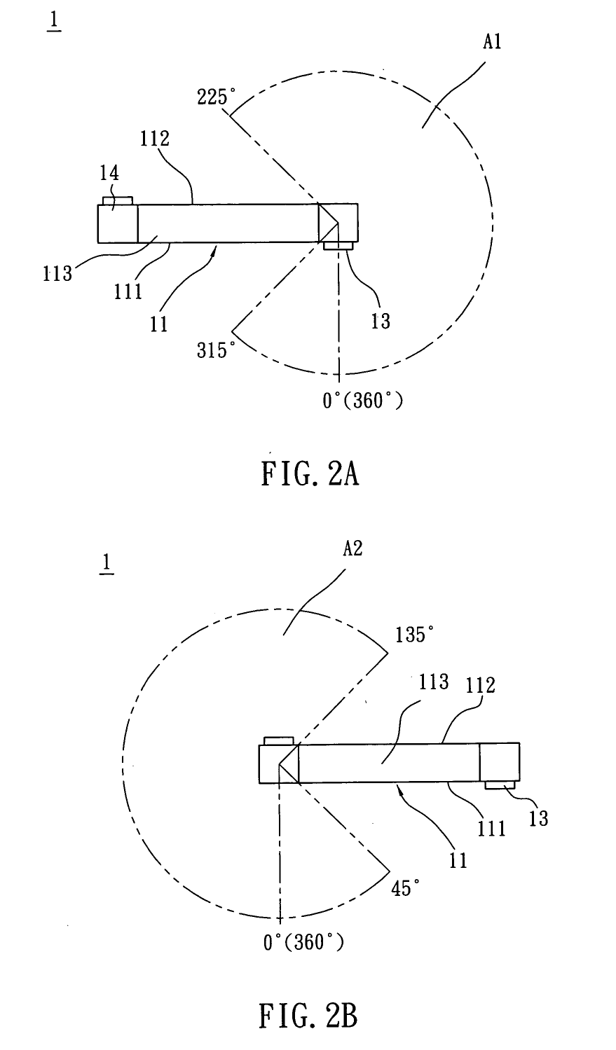

As shown in FIGS. 1, 2A and 2B, the host 11 having, for example, a rectangular-shaped host has a front side 111, a backside 112, a top surface 113 and a bottom surface 114. The top surface 113 of the host 11 has a top-surface right side 113a and a top-surface left side 113b respectively disposed on two opposite sides of the top surface 113. The top surface 113 further has an accommodating space 115. Of course, the exterior shape of the host 11 and the position of the accommodating space 115 may be modified according to other aspects. In addition, the host 11 has a key input unit 116, a display unit 117 and a voice player unit 118. In this embodiment, each of the units 116 to 118 is disposed on the front side 111 of the host 11. In addition, the user can input a signal or an instruction through the key input unit 116. The host 11 receives the signal or the instruction and performs a corresponding operation. The key input unit 116 has a call/answer key 116a and an end key 116b. The user can control the ON/OFF between the host 11 and a remote electronic device (not shown) through the call/answer key 116a and the end key 116b. The display unit 117 displays the image, and the voice player unit 118 plays the voice. However, the structures and the operations of the key input unit 116, the display unit 117 and the voice player unit 118 are not the key points of the invention, and detailed descriptions thereof will be omitted.

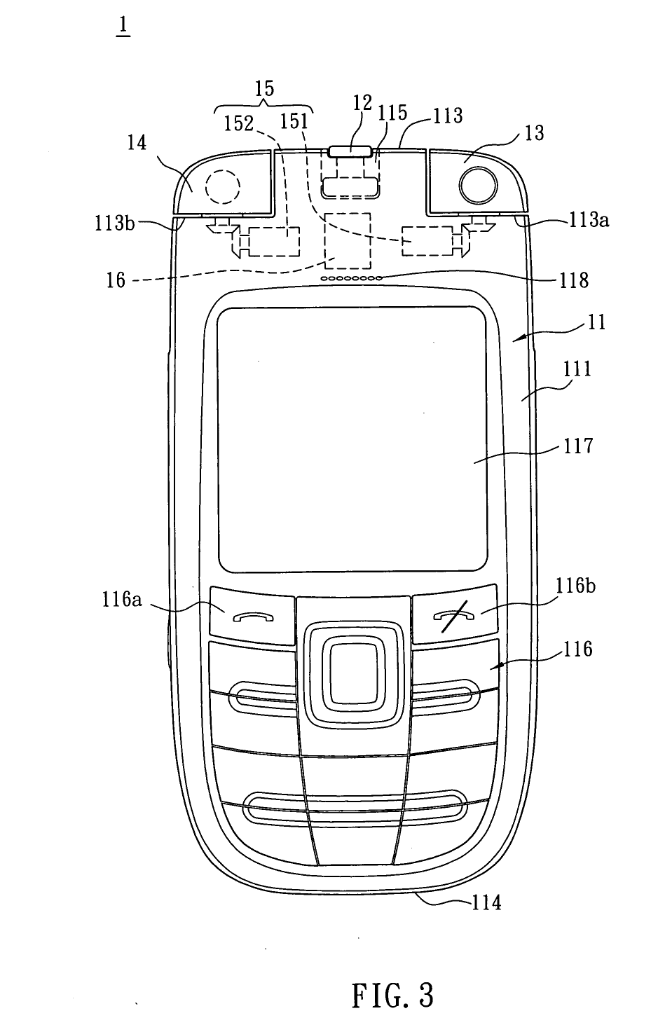

As shown in FIG. 1, the microphone module 12 is connected to the host 11. In this embodiment, the microphone module 12 is an omnidirectional microphone module capable of receiving any voice coming from any direction. In addition, the microphone module 12 is pivotally connected to the host 11. In this embodiment, the microphone module 12 is pivotally mounted in the accommodating space 115 of the host 11. When the microphone module 12 is being used, the microphone module 12 is lifted out of the accommodating space 115. When the microphone module 12 is in a stored state, the microphone module 12 is disposed in the accommodating space 115, as shown in FIG. 3.

The first camera module 13 is disposed on the top-surface right side 113a of the host 11. As shown in FIG. 2A, the first camera module 13 can be rotated relative to the host 11 to have a first photographing range A1, and the first photographing range A1 relates to the structural dimensions or position of the host 11 and the first camera module 13. In this embodiment, the point directly in front of the front side 111 of the host 11 is defined as 0 degrees, and the first photographing range A1 of the first camera module 13 ranges from 0 to 225 degrees and 315 to 360 degrees.

The second camera module 14 is disposed on the top-surface left side 113b of the host 11 relative to the first camera module 13. Of course, the arrangement and position of the second camera module 14 may also be changed according to the position of the first camera module 13. As shown in FIG. 2B, the second camera module 14 may be rotated relative to the host 11 in order to produce a second photographing range A2. The photographing range closely relates to the structural dimensions or the position of the host 11 and the second camera module 14. In this embodiment, the point directly in front of the front side 111 of the host 11 is defined as 0 degrees, and the second photographing range A2 of the second camera module 14 ranges from 0 to 45 degrees and from 135 to 360 degrees. The first photographing range A1 of the first camera module 13 or the second photographing range A2 of the second camera module 14 may be adjusted according to the actual operation. If the host 11 serves as the center, the overall coverage of the first photographing range A1 and the second photographing range A2 is 360 degrees such that the circumference of the host 11 is located within the photographic ranges A1 and A2 of the first camera module 13 and the second camera module 14.

The driving module 15 disposed in the host 11 is connected to the first camera module 13 and the second camera module 14 to drive the first camera module 13 and the second camera module 14 to turn. In this embodiment, the driving module 15 has a first motor 151 and a second motor 152. The first motor 151 drives the first camera module 13 to turn by using its gear set (not shown), and the second motor 152 drives the second camera module 14 to turn by using its gear set (not shown). The first motor 151 or the second motor 152 may be a micro driving motor. Because the operating principle of the gear set of the first motor 151 and the gear set of the second motor 152 may be easily understood the detailed descriptions thereof will be omitted.

The control module 16 disposed in the host 11 is connected to the microphone module 12, the first camera module 13, the second camera module 14 and the driving module 15. In this embodiment, the microphone module 12 and a circuit board (not shown) are connected by a flexible circuit board. Of course, the microphone module 12 may also be directly disposed on the circuit board. In addition, each of the first camera module 13 and the second camera module has a flexible circuit board (not shown) to be connected to the circuit board (not shown), and the control module 16 and the driving module 15 are respectively and directly disposed on the circuit board (not shown). Thus, the microphone module 12, the first camera module 13 and the second camera module 14 may be electrically connected to the control module 16 through the circuit board. When the first camera module 13 is enabled (e.g., a conference mode is entered) and the microphone module 12 receives a voice source, the control module 16 can judge the orientation of the voice source and select to adjust the first camera module 13 or enable the second camera module 14. When the control module 16 adjusts the first camera module 13, the control module 16 activates the first motor 151 of the driving module 15 to drive the first camera module 13 to turn. When the control module 16 enables the second camera module 14 the control module 16 enables the second motor 152 of the driving module 15 to drive the second camera module 14 to turn. So, the control module 16 may adjust the first camera module 13 or the second camera module 14 according to the voice source and adjust the first camera module 13 or the second camera module 14 by driving the first motor 151 or the second motor 152. In addition, the control module 16 may also adjust a first focal length of the first camera module 13 or a second focal length of the second camera module 14 such that the first camera module 13 or the second camera module 14 can automatically focus.

The procedure of implementing the video conference between a user and a remote user using the electronic device 1 according to the preferred embodiment of the invention will be described in the following.

The user firstly connects the host 11 to a remote electronic device through the network using the key input unit 116 of the host 11. When the electronic device 1 selects to enter a conference mode, the control module 16 enables the first camera module 13. Thereafter, the microphone module 12 may receive the voice of the user. When the control module 16 judges that the voice source is located within the first photographing range A1 of the first camera module 13, the control module 16 adjusts the first camera module 13 to turn toward the voice source. When the control module 16 judges that the voice source is located within the second photographing range A2 of the second camera module 14, the control module 16 activates the second camera module 14 and adjusts the second camera module 14 to turn toward the voice source. In addition, the control module 16 may control the driving module 15, adjust the position of the first camera module 13 or the second camera module 14, and adjust the first focal length of the first camera module 13 or the second focal length of the second camera module 14 such that the first camera module 13 or the second camera module 14 can photograph a clear and appropriate image. Thereafter, the voice received by the microphone module 12 and the images photographed by the camera modules 13 and 14 may be transmitted to the remote electronic device through the network. Similarly, the remote electronic device may also transmit the remote voice and images to the electronic device 1 in a similar manner. At this time, the display unit 117 and the voice player unit 118 of the electronic device 1 can play the received voice and images such that the video conference can proceed smoothly.

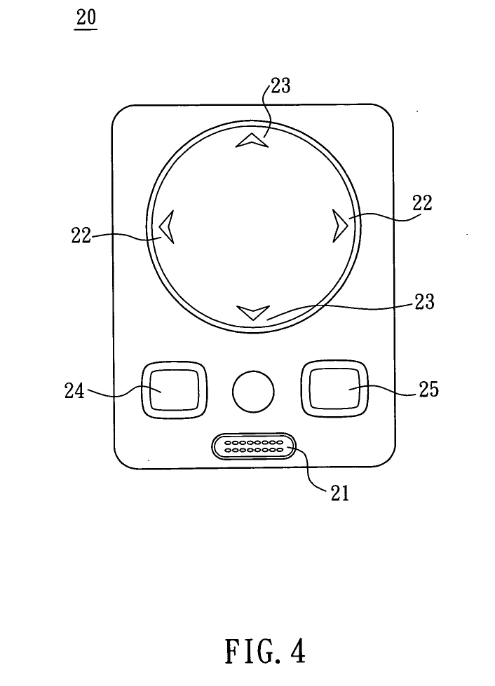

Referring to FIG. 4, the electronic device 1 further includes a remote control module 20. In this embodiment, the control module 16 receives a positioning signal of the remote control module 20 and then can judge the orientation of the remote control module 20 to activate the first camera module 13 or the second camera module 14. The remote control module 20 has a voice receiving unit 21, a lens adjusting unit 22, a focal length adjusting unit 23, a voice-controlled dialing unit 24 and a talk control unit 25. The voice receiving unit 21 is substantially a microphone, which may be a directional microphone or an omnidirectional microphone. In addition, the lens adjusting unit 22 may output a lens adjusting signal, and the control module 16 may control the first motor 151 or the second motor 152 of the driving module 15 according to the lens adjusting signal to drive the first camera module 13 or the second camera module 14 to turn. In addition, the focal length adjusting unit 23 outputs a focal length adjusting signal, and the control module 16 adjusts the first lens focal length of the first camera module 13 or the second lens focal length of the second camera module 14 according to the focal length adjusting signal. The voice-controlled dialing unit 24 may generate a talk instruction according to the user's voice, and the host 11 receives the talk instruction and is thus connected to the remote electronic device through the network. The talk control unit 25 can generate a talk control signal to control the ON/OFF connection between the host 11 and the remote electronic device.

The procedures of implementing the video conference between a user and a remote user using the remote control module 20 of the electronic device 1 according to the preferred embodiment of the invention will be described in the following.

The user holds the remote control module 20 in his or her hand, and the host 11 is connected to the remote electronic device via the network through the voice-controlled dialing unit 24 and the talk control unit 25. Thereafter, the user may speak directly into the voice receiving unit 21 and adjust the position of the first camera module 13 or the second camera module 14 of the host 11 using the lens adjusting unit 22 by way of remote control. Also, the user may adjust the first focal length of the first camera module 13 or the second focal length of the second camera module 14 using the focal length adjusting unit 23. Finally, the voice received by the voice receiving unit 21 and the images photographed by the camera modules 13 and 14 may be transmitted to the remote electronic device through the network. Thus, the video conference between the user and the remote user maybe performed.

Although the invention has been described with reference to specific embodiments, this description is not meant to be construed in a limiting sense. Various modifications of the disclosed embodiments as well as alternative embodiments, will be apparent to persons skilled in the art. It is, therefore, contemplated that the appended claims will cover all modifications that fall within the true scope of the invention.

What is claimed is:

1. An electronic device, comprising:
a host;
a microphone module connected to the host;
a first camera module;
a second camera module, wherein the first camera module and the second camera module are respectively disposed on two opposite sides of the host;
a driving module, which is disposed in the host and connected to the first camera module and the second camera module, for driving the first camera module and the second camera module to turn; and
a control module disposed in the host and connected to the microphone module, the first camera module, the second camera module and the driving module.

2. The electronic device according to claim 1, wherein the host has an accommodating room, the microphone module is pivotally connected to the host and has a functioning state and a stored state, the microphone module is located in the accommodating space when the microphone module is in the stored state, and the microphone module is moved out of the accommodating space when the microphone module is in the functioning state.

3. The electronic device according to claim 1, wherein the microphone module is an omnidirectional microphone module.

4. The electronic device according to claim 1, wherein the driving module has a first motor, and the control module enables the first motor to drive the first camera module to turn.

5. The electronic device according to claim 1, wherein the driving module has a second motor, and the control module enables the second motor to drive the second camera module to turn.

6. The electronic device according to claim 1, wherein the control module adjusts a first focal length of the first camera module or a second focal length of the second camera module.

7. The electronic device according to claim 1, wherein the first camera module, which turns in relation to the host, has a first photographic range, the second camera module, which turns in relation to the host, has a second photographic range, and the combined range of the first photographic range and the second photographic range is 360 degrees about the host with respect to the host as center.

8. The electronic device according to claim 1, wherein the microphone module receives a voice source, and the control module judges an orientation of the voice source to adjust the first camera module or the second camera module.

9. The electronic device according to claim 1, further comprising:
a remote control module, wherein the control module judges an orientation of the remote control module to enable the first camera module or the second camera module.

10. The electronic device according to claim 9, wherein the remote control module has a lens adjusting unit for outputting a lens adjusting signal, and the control module drives a first motor or a second motor according to the lens adjusting signal to drive the first camera module or the second camera module to turn.

11. The electronic device according to claim 9, wherein the remote control module has a focal length adjusting unit, the focal length adjusting unit outputs a focal length adjusting signal, and the control module adjusts a first lens focal length of the first camera module or a second lens focal length of the second camera module according to the focal length adjusting signal.

12. The electronic device according to claim 9, wherein the remote control module has a voice receiving unit.

13. The electronic device according to claim 9, wherein the remote control module has a voice-controlled dialing unit.

14. The electronic device according to claim 9, wherein the remote control module has a talk control unit.

15. The electronic device according to claim 1, wherein the electronic device is a portable electronic device.

16. The electronic device according to claim 15, wherein the electronic device is a mobile phone or a personal digital assistant (PDA).
